(19) United States
(12) Patent Application Publication
(10) Pub. No.: US 2023/0246854 A1
(43) Pub. Date: Aug. 3, 2023

(54) SYSTEM AND METHOD FOR ON-DEMAND PRODUCT CERTIFICATION VIA NON-FUNGIBLE TOKEN

(71) Applicant: Kreatr, Inc., Irvine, CA (US)

(72) Inventor: Stephen Thorpe, Lake Forest, CA (US)

(21) Appl. No.: 18/104,744

(22) Filed: Feb. 1, 2023

Related U.S. Application Data
(60) Provisional application No. 63/305,664, filed on Feb. 1, 2022.

(51) Int. Cl. H04L 9/00; H04L 9/32

(52) U.S. Cl. CPC H04L 9/50; H04L 9/3247

(57) ABSTRACT

A system, and a method executed thereon, may generate a unique globally unique identifier (GUID) for a product. The system may encode a readable identifying device with the GUID and a base uniform resource locator (URL). The system may lock the GUID and the base URL in a non-fungible token (NFT) before physical association of the readable identifying device with the product. The system may add the NFT to a cryptographic blockchain configured for being managed on a data network. The system may physically associate the readable identifying device with the product, the readable identifying device being readable by a computing device to link a reader application to the blockchain. Numerous other aspects are described.

### CROSS-REFERENCES TO RELATED APPLICATIONS

The present application claims priority of U.S. Provisional Application No. 63/305,664, filed Feb. 1, 2022, and entitled “SYSTEM AND METHOD FOR ON DEMAND PRODUCT CERTIFICATION VIA NON-FUNGIBLE TOKEN”, the entirety of which is incorporated by reference herein.

### TECHNICAL FIELD

The subject matter described herein relates to digital certification and authentication of trackable assets, and more particularly to certification of a product using non-fungible tokens (NFTs). The product can be any tangible, physical item, or can be a digital representation of a tangible, physical item.

### BACKGROUND

Since the beginning of time, art and collectibles, also referred to herein as “products,” which includes digital content and tangible products or assets, have shaped people's culture. More and more, art and collectibles are provided in the form of digital content, such as digital music, videos, or images, as just some examples.

Certain gatekeepers, such as art galleries, auction houses, record labels, film studios, etc., are all barriers to creators to thrive and connect directly to their potential audience. This causes creators to gravitate to social media and other social platforms to promote themselves and their creations. At the same time, collectors of art have little or no direct access to creators. In social media platforms, messaging is lost within a clutter of advertisements and other content prioritized by social networks. This is mainly due to social networks not being able to share in the value of art creation and sharing it with collectors and others.

Today, new digital interfaces, such as non-fungible tokens (NFTs), are yielding new forms of expression, as well as opportunities to collect, own, and monetize digital content as well as tangible products, such as a wall-mounted artwork. An NFT is a unique unit of data that is configured to be stored on a blockchain, and can be associated with reproducible digital files, which can represent digital content or tangible products.

### SUMMARY

In some aspects, this document presents a platform to monetize digital and tangible creations, by providing system to certify digital and physical assets using NFTs, and providing an online destination to create, collaborate, discover, collect and trade these certified digital and physical assets, between creators and collectors.

Some aspects described herein provide a method, and a system configured to execute the method, of on-demand product certification and chain-linking the certification. The method may include generating a unique globally unique identifier (GUID) for a product. The method may include encoding a readable identifying device with the GUID and a base uniform resource locator (URL). The method may include locking the GUID and the base URL in a non-fungible token (NFT) before physical association of the readable identifying device with the product. The method may include adding the NFT to a cryptographic blockchain configured for being managed on a data network. The method may include using a cryptographically unique signature from a bitmap image or digital file captured of the unique physical product and adding to the NFT. The method may include physically associating the readable identifying device with the product, the readable identifying device being readable by a computing device to link a reader application to the blockchain.

In some aspects, a method, system, computer program product, and non-transitory computer-readable medium include a process for generating a globally unique identifier (GUID) for a product, the product comprising one or more of a digital asset, a tangible good, and an experience. The process includes encoding a readable identifying device with the GUID and a base uniform resource locator (URL), the readable identifying device being configured to be physically associated with the product. The process further includes locking the GUID and the base URL in a non-fungible token (NFT), and adding the NFT to a cryptographic blockchain that is configured for being managed on a data network.

The readable identifying device is one or more of a near-field communication (NFC) chip, a quick response (QR) code, a radio frequency identifier (RFID) tag, and/or a Bluetooth transmitter. In other aspects, the process further includes adding the cryptographically unique signature to the NFT, and wherein the readable identifying device is readable by a computing device to link a reader application to the cryptographic blockchain on the data network.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

In some implementations, a non-transitory computer-readable medium is provided that stores a set of instructions for executing the methods described herein. The set of instructions includes one or more instructions that, when executed by one or more processors of a system, cause the system to execute the methods described herein. In yet other implementations, a system is provided for executing the method described above. The system can include one or more memories, and one or more processors, communicatively coupled to the one or more memories, and which are configured to execute the methods described herein.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to on-demand product certification and chain-linking the certification, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a process flow diagram illustrating aspects of a method having one or more features consistent with implementations of the current subject matter;

FIG. 2 is a detailed process flow diagram of an original collectible certification and chain-linking/meta-linking process, consistent with implementations of the current subject matter;

FIG. 3 is a detailed process flow diagram of an on-demand product certification and chain-linking/meta-linking process, consistent with implementations of the current subject matter; and

FIG. 4 illustrates exemplary readable identifying device certificates, consistent with implementations of the current subject matter.

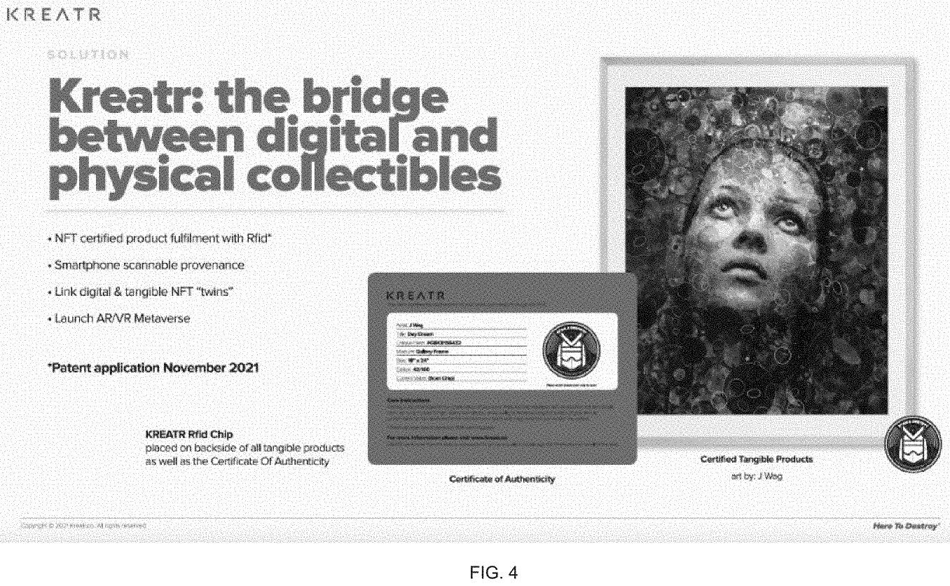

When practical, similar reference numbers denote similar structures, features, or elements.

### DETAILED DESCRIPTION

This document describes systems and methods for certifying digital and physical assets using NFTs, and providing an online destination to create, collaborate, discover, collect and trade these certified digital and physical assets between creators and collectors. The NFTs and image of digital and physical assets can be processed by machine learning (ML) and artificial intelligence (AI) processors to match products with the platform's users.

For creators and artists, the systems and methods described herein provide access to a highly targeted network of collectors, buyers, and market influencers, and an ability to earn when their work or products are sold on a secondary market. Further, the systems and methods described herein can be used to verify scarcity and authenticity of digital content and tangible products (herein referred to collectively as “products”), by a proprietary minting process that supports original works or products, or reproductions. Accordingly, creators and artists can reduce time spent on self-marketing, sales and fulfillment.

For curators and influencers, i.e., people between creators and collectors who facilitate the discovery of products and transactions between them, the systems and methods allow them to earn from work added to product collections under their purview, while driving traffic between creators and collectors without contract friction. Finally, for collectors and fans, the systems and methods can provide direct access to creators, cutting out some middlemen and other gatekeepers in transactions. Further, the systems and methods can be used to curate a personal digital “museum” of digital and physical collectible products in a collection, from which collectors can verify authenticity and ownership history, and earn from sales of certain products on secondary markets.

As described above, in preferred implementations of the subject matter described herein, systems and methods use NFTs for certifying digital and physical assets, and providing an online destination to create, collaborate, discover, collect and trade certified digital and physical assets in transactions between creators and collectors. NFTs are cryptographic tokens, but unlike cryptocurrencies, NFTs are not mutually interchangeable and are therefore non-fungible. The unique identity and ownership of an asset is verifiable and certified by an NFT, via the blockchain ledger.

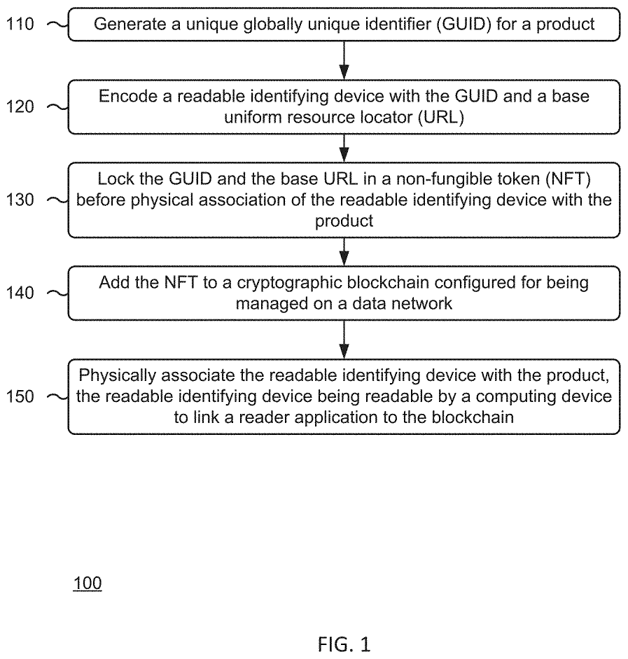

FIG. 1 is a flowchart of an example process 100 associated with a system and method for on-demand product certification via NFT. In some implementations, one or more process blocks of FIG. 1 may be performed by a user device (e.g., a mobile computing device such as a smartphone, with a camera and an application, for instance). In other implementations, one or more process blocks of FIG. 1 may be performed by another device, or a group of devices separate from or including the user device.

As shown in FIG. 1, process 100 may include generating a unique globally unique identifier (GUID) for a product (block 110). For example, the device may generate a unique globally unique identifier (GUID) for a product, as described above. As further shown in FIG. 1, process 100 may include encoding a readable identifying device with the GUID and or a base uniform resource locator (URL) (block 120). For example, the device may encode a readable identifying device with the GUID and or a base uniform resource locator (URL), as described above.

As further shown in FIG. 1, process 100 may include locking the GUID and or the base URL in a non-fungible token (NFT) before physical association of the readable identifying device with the product (block 130). For example, the device can lock the GUID and or the base URL in a non-fungible token (NFT) before physical association of the readable identifying device with the product, as described above.

As further shown in FIG. 1, process 100 may include adding the NFT to a cryptographic blockchain configured for being managed on a data network (block 140). For example, the device can add the NFT to a cryptographic blockchain configured for being managed on a data network, as described above.

As further shown in FIG. 1, the process 100 may include physically associating the readable identifying device with the product, the readable identifying device being readable by a computing device to link a reader application to the blockchain (block 150). For example, the device may physically associate the readable identifying device with the product, the readable identifying device being readable by a computing device to link a reader application to the blockchain, as described above.

Process 100 may include additional implementations, such as any single implementation or any combination of implementations described below and/or in connection with one or more other processes described elsewhere herein. For example, in some implementations, the readable identifying device to certify the asset can be one or more of a near-field communication (NFC) chip, a quick response (QR) code, a radio frequency identifier (RFID) tag, and/or a Bluetooth transmitter.

In some implementations, process 100 includes acquiring a digital photograph of the product, associating the digital photograph of the product with the NFT, and storing the NFT in a collection of NFTs associated with the product certification. In some implementations, process 100 can further include digitally fingerprinting or obtaining a unique cryptographic signature or hash and saving the digital fingerprint and/or unique cryptographic signature to the NFT to uniquely identify the asset by way of its unique visual details.

Once fingerprinted and/or certified, the asset is formed as “gated content,” whereby the current owner of the asset is known, and anyone seeking access to the asset will have to perform some action (i.e., scan its associated NFC chip, QR code, RFID tag or Bluetooth transmitter, or the like) in order to gain access to the asset, and thereafter perform certain other additional actions such as purchasing the asset, reselling the asset, trading the asset, or the like. In this way, the owner of the asset can control each asset's discover, collection, purchasing and reselling by any third parties.

Accordingly, the system and process described herein can be used to turn any creation into a utility token, using a token manager of an application, to deploy, update, and track assets, such as digital content, tangible goods, and even experiences, for asset owners. The system and process can be used to provide ownership and pricing history of each asset, provide the latest gated content, and indicate or provide an ability to purchase an asset by a third party, or resell the asset by a first purchaser to a second purchaser.

Although FIG. 1 shows example blocks of process 100, in some implementations, process 100 may include additional blocks, fewer blocks, different blocks, or differently arranged blocks than those depicted in FIG. 1. Additionally, or alternatively, two or more of the blocks of process 100 may be performed in parallel.

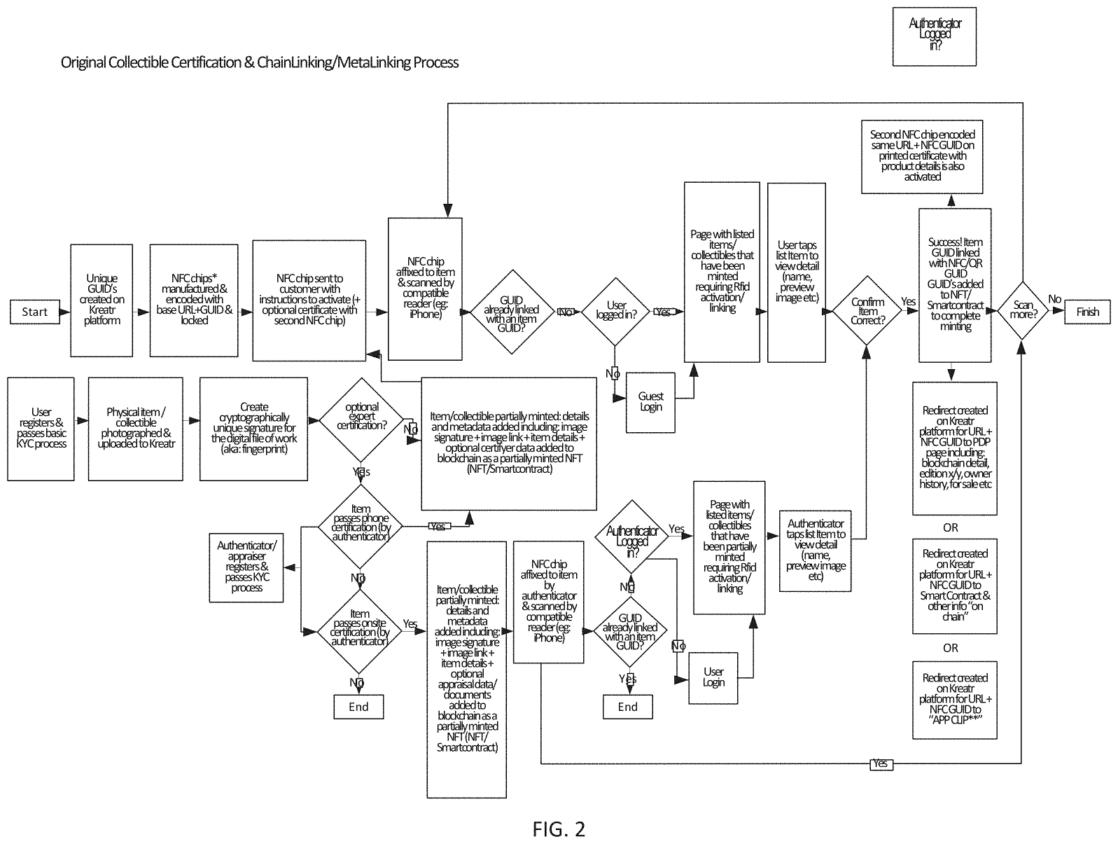

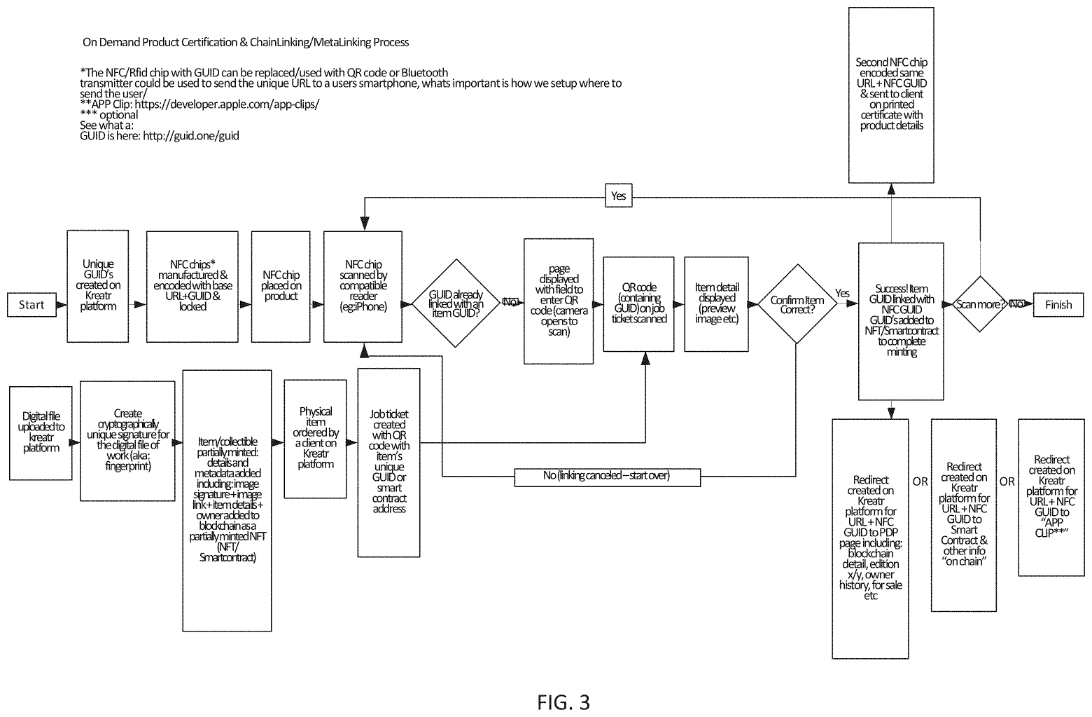

FIG. 2 is a detailed process flow diagram of an original collectible certification and chain-linking/meta-linking process, consistent with implementations of the current subject matter. FIG. 3 is a detailed process flow diagram of an on-demand product certification and chain-linking/meta-linking process, consistent with implementations of the current subject matter, in which an image copy of a product is certified and processed.

In some implementations, for each uploaded image, a cryptographically unique signature is created for the bitmap/image, which forms a unique signature/fingerprint or token. Next, the token can be at least partially “minted” with properties and metadata and include the signature/fingerprint. Optionally, or alternatively, appraisal documents for an original work can also be uploaded and added to the token as a link to their image files (e.g., PDF, JPG, etc.) on the Interplanetary File System (IPFS) or other proprietary file system, and preferably a cloud-based file system. After the product or work of art is sold to a customer, the RFID tag is processed as disclosed in FIG. 2, however the RFID tag GUID is added to the token to fully “mint” the NFT (i.e., publishing the unique digital asset represented by the NFT on a blockchain so that it can be bought, sold, traded, etc.). Accordingly, the new owner now has the complete token with image fingerprint with the RFID of the work on it.

In various implementations, methods of on-demand product certification and chain-linking the certification can include steps of generating a unique globally unique identifier (GUID) for a product, encoding a readable identifying device with the GUID and/or a base uniform resource locator (URL), and locking the GUID and/or the base URL in a non-fungible token (NFT) before physical association of the readable identifying device with the product. Some methods can further include adding the NFT to a cryptographic blockchain configured for being managed on a data network, and physically associating the readable identifying device with the product, the readable identifying device being readable by a computing device to link a reader application to the blockchain.

The methods can further include acquiring a digital photograph of the product and associating the digital photograph of the product with the NFT. In some implementations, the cryptographic signature of images/similarities are compared to that saved to the NFT or similar. The methods can further include storing the NFT in a collection of NFTs associated with the product certification. As discussed above, the NFTs and image(s) of the digital and physical assets can be processed by machine learning (ML) processors and artificial intelligence (AI) algorithms to match products with the platform's users, and/or to discern by the application whether the object or asset is verifiable as the unique owned object or asset.

Further, implementations of the current subject matter can be used to create a social marketplace for creators of assets, whether digital assets, tangible goods such as artwork or other goods, or experiences such as performances, concerts, etc. This social marketplace can be implemented in an application for the asset creators and third parties to discover, collect and sell assets. The discovery of assets can be facilitated and powered by AI/ML processors, and whereby influencers can curate exhibits of assets on behalf of owners and creators, and earn on the marketing of assets. Further, the systems and methods described herein can provide intelligence for price suggestions, marketing automation, and positioning of assets on social media or other digital or online marketplaces.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired conFIGuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying FIGS. and/or described herein do not necessarily require the particular order shown, or sequential order, to achieve desirable results. Other implementations may be within the scope of the following claims.

What is claimed is:

1. A method comprising:
generating a globally unique identifier (GUID) for a product, the product comprising one or more of a digital asset, a tangible good, and an experience;
encoding a readable identifying device with the GUID and a base uniform resource locator (URL), the readable identifying device being configured to be physically associated with the product;
locking the GUID and the base URL in a non-fungible token (NFT); and
adding the NFT to a cryptographic blockchain that is configured for being managed on a data network.

2. The method in accordance with claim 1, further comprising using a cryptographically unique signature from a bitmap image or digital file of the product for the cryptographic blockchain.

3. The method in accordance with claim 2, further comprising adding the cryptographically unique signature to the NFT.

4. The method in accordance with claim 1, further comprising associating the readable identifying device with the product.

5. The method in accordance with claim 4, wherein the readable identifying device is associated with the product physically.

6. The method in accordance with claim 1, wherein the readable identifying device is one or more of a near-field communication (NFC) chip, a quick response (QR) code, a radio frequency identifier (RFID) tag, and/or a Bluetooth transmitter.

7. The method in accordance with claim 6, wherein the readable identifying device is readable by a computing device to link a reader application to the cryptographic blockchain on the data network.

8. A non-transitory computer-readable medium storing a set of instructions, the set of instructions comprising:
one or more instructions that, when executed by one or more processors of a system, cause the system to perform operations comprising:
generate a globally unique identifier (GUID) for a product, the product comprising one or more of a digital asset, a tangible good, and an experience;
encode a readable identifying device with the GUID and a base uniform resource locator (URL), the readable identifying device being configured to be physically associated with the product;
lock the GUID and the base URL in a non-fungible token (NFT); and
add the NFT to a cryptographic blockchain that is configured for being managed on a data network.

9. The non-transitory computer-readable medium in accordance with claim 8, wherein the operations further comprise using a cryptographically unique signature from a bitmap image or digital file of the product for the cryptographic blockchain.

10. The non-transitory computer-readable medium in accordance with claim 9, wherein the operations further comprise adding the cryptographically unique signature to the NFT.

11. The non-transitory computer-readable medium in accordance with claim 8, wherein the operations further comprise associating the readable identifying device with the product.

12. The non-transitory computer-readable medium in accordance with claim 11, wherein the readable identifying device is associated with the product physically.

13. The non-transitory computer-readable medium in accordance with claim 8, wherein the readable identifying device is one or more of a near-field communication (NFC) chip, a quick response (QR) code, a radio frequency identifier (RFID) tag, and/or a Bluetooth transmitter.

14. The non-transitory computer-readable medium in accordance with claim 13, wherein the readable identifying device is readable by a computing device to link a reader application to the cryptographic blockchain on the data network.

15. A system, comprising:
one or more memories; and
one or more processors, communicatively coupled to the one or more memories, the one or more processors being configured to perform operations comprising:
generate a globally unique identifier (GUID) for a product, the product comprising one or more of a digital asset, a tangible good, and an experience;
encode a readable identifying device with the GUID and a base uniform resource locator (URL), the readable identifying device being configured to be physically associated with the product;
lock the GUID and the base URL in a non-fungible token (NFT); and
add the NFT to a cryptographic blockchain that is configured for being managed on a data network.

16. The system in accordance with claim 15, wherein the operations further comprise using a cryptographically unique signature from a bitmap image or digital file of the product for the cryptographic blockchain.

17. The system in accordance with claim 16, wherein the operations further comprise adding the cryptographically unique signature to the NFT.

18. The system in accordance with claim 15, wherein the operations further comprise associating the readable identifying device with the product.

19. The system in accordance with claim 18, wherein the readable identifying device is associated with the product physically.

20. The system in accordance with claim 15, wherein the readable identifying device is one or more of a near-field communication (NFC) chip, a quick response (QR) code, a radio frequency identifier (RFID) tag, and/or a Bluetooth transmitter.
